(19) United States
(12) Patent Application Publication
(10) Pub. No.: US 2025/0115035 A1
(43) Pub. Date: Apr. 10, 2025

(54) POLYESTER MULTI-LAYER FILM AND MANUFACTURING METHOD THEREFOR

(71) Applicant: TORAY ADVANCED MATERIALS KOREA INC., Gumi-si (KR)

(72) Inventors: Kil Joong KIM, Gumi-si (KR); Sang Wook JUNG, Gumi-si (KR); Seong Yong PARK, Gumi-si (KR); Kyu Suk LEE, Gumi-si (KR)

(73) Assignee: TORAY ADVANCED MATERIALS KOREA INC., Gumi-si (KR)

(21) Appl. No.: 18/729,444

(22) PCT Filed: Mar. 22, 2023
(86) PCT No.: PCT/KR2023/003803

§ 371 Date: Jul. 16, 2024

(30) Foreign Application Priority Data
Mar. 25, 2022 (KR) 10-2022-0037506

(51) Int. Cl. B32B 27/18; B29C 48/00; B29C 48/08; B29C 48/21; B29K 67/00; B32B 7/02; B32B 27/08; B32B 27/36; C08K 5/49

(52) U.S. Cl. CPC B32B 27/18; B29C 48/0018; B29C 48/022; B29C 48/08; B29C 48/21; B32B 7/02; B32B 27/08; B32B 27/36; C08K 5/49; B29K 2067/00; B29K 2995/0026; B29K 2995/0053; B32B 2250/03; B32B 2250/244; B32B 2250/40; B32B 2307/412; B32B 2307/516; B32B 2307/518; B32B 2307/7376

(57) ABSTRACT

A polyester multi-layer film of the present invention comprises: a substrate layer comprising polyester; and a skin layer located on at least one surface of the substrate layer, wherein the polyester multi-layer film suppresses generation of oligomers in the film and migration to the surface even in a high-temperature treatment process by satisfying a predetermined correlation between the concentration of cyclic oligomers in the film and a haze value before and after heat treatment, thereby maintaining transparency and visibility of the film in the long term.

### TECHNICAL FIELD

The present invention relates to a polyester multi-layer film with excellent transparency, and to an economical polyester multi-layer film that suppresses the generation of oligomers within the film and their migration to the surface, thereby maintaining transparency even when used in a high-temperature process, and a manufacturing method therefor.

### BACKGROUND ART

In general, polyester films possess excellent durability, remarkable stability of physical properties across a wide temperature range from low to high temperatures, superior chemical resistance compared to other polymer resins, and good mechanical strength and surface characteristics. Due to these outstanding physical and chemical properties, polyester films are widely used in displays, semiconductors, and other industrial applications. Specifically, their excellent transparency and visibility, along with superior mechanical and electrical properties, have led to a continuous increase in their use as optical films for displays such as LCDs and touch panels.

However, since polyester films require high temperatures exceeding 100° C. in the process of manufacturing displays, etc., there is a problem in that low-molecular-weight oligomers within the polyester film are migrated to the surface, and the migrated oligomers may result in the formation of crystalline foreign substances, known as blooming phenomenon, which not only degrade transparency but also cause contamination due to scattering within the process, thereby reducing productivity.

To prevent oligomers in polyester films from migrating to the surface, methods of reducing the oligomer content through solid-state polymerization during the polymerization of polyester films are widely used. However, the complicated solid-state polymerization process not only increases costs but also fails to completely block oligomers since oligomers continue to generate within the film at high temperatures and migrate to the surface.

In addition, other methods to prevent oligomer from migrating to the surface include using high-heat-resistant polymers such as polyethylene naphthalate (PEN), as described in Korean Patent No. 10-1733193, or applying copolymers using monomers such as isophthalate or cyclohexane dimethanol instead of terephthalic acid or ethylene glycol, as described in Korean Patent No. 10-1842456. However, these methods may alter the physical properties of the polyester and ultimately fail to suppress the migration of oligomers to the surface.

Moreover, technologies have been reported that form a laminated layer on a polyester film and use high-viscosity polymers obtained through solid-state polymerization in a skin layer to control oligomer migration. However, these methods lack economic feasibility due to the use of expensive catalysts and do not completely block oligomer migration.

Meanwhile, Korean Patent No. 10-1424838 suggests improving the color tone of a film by using a phosphorus compound during the resin polymerization stage. However, this approach, which is a method for manufacturing polyester itself, involves complex manufacturing processes that increase manufacturing costs due to issues such as suppressing the activity of the catalyst essential in the polymerization reaction and is not related to preventing the generation and migration of oligomers.

### DETAILED DESCRIPTION OF THE INVENTION

### Technical Problem

The present invention was devised to solve the aforementioned problems, and an object to be achieved by the present invention is to provide a polyester multi-layer film that suppresses generation of oligomers in the film and migration to the surface even in a high-temperature treatment process, thereby maintaining transparency and visibility of the film in the long term, and a manufacturing method therefor.

The above and other objects and advantages of the present invention will become apparent from the following description of preferred embodiments.

### Technical Solution

The above object is achieved by a polyester multi-layer film including a substrate layer including polyester and a skin layer located on at least one surface of the substrate layer and including polyester and an organic phosphorus compound, wherein the polyester multi-layer film satisfies Equation 1 and Equation 2 below,

$$0.5 < [ C 3 ] / 10 , 000 - Δ H < 1 \qquad ( Equation 1 )$$

$$Δ H = H f - Hi < 0.5 \% , \qquad ( Equation 2 )$$

where [C3] represents the ppm concentration of C3 cyclic oligomers contained in the multi-layer film, Hi is the haze of the multi-layer film, and Hf is the haze (unit: %) of the multi-layer film after heat treatment at 150° C. for 30 minutes.

Preferably, the polyester multi-layer film may satisfy Equation 3 below,

$$10 , 000 < [ C 3 ] + [ P ] * 20 < 15 , 000 , \qquad ( Equation 3 )$$

where [C3] represents the ppm concentration of C3 cyclic oligomers contained within the multi-layer film and [P] represents the ppm concentration of phosphorus (P) contained in the skin layer.

Preferably, the skin layer may have a C3 cyclic oligomer concentration of 7,000 ppm or less.

Preferably, the organic phosphorus compound may have a molecular weight of from 400 to 900 g/mol.

Preferably, the organic phosphorus compound may act like a C3 cyclic oligomer, allowing for an equilibrium state to be maintained at high temperatures, thereby suppressing the generation of C3 cyclic oligomers within the film.

Preferably, the organic phosphorus compound may be at least one selected from triaryl phosphite and trialkyl phosphite.

Preferably, the organic phosphorus compound in the skin layer may be added as a master-batch chip that is produced by compounding an organic phosphorus compound separately from polyester resin.

Preferably, the thickness ratio of the substrate layer to the skin layer may be in the range of 6:1 to 13:1.

In addition, the above object may be achieved by a method for manufacturing a polyester multi-layer film, which includes the steps of: preparing a master-batch chip by compounding an organic phosphorus compound separately from polyester resin, preparing a polyethylene terephthalate sheet by blending the prepared master-batch chip with polyester resin and then co-extruding it onto a polyester film, preparing a uniaxially stretched polyester multi-layer film by uniaxially stretching the polyethylene terephthalate sheet in the machine direction and then cooling it to room temperature, and preparing a biaxially stretched polyester multi-layer film by biaxially stretching the uniaxially stretched polyester multi-layer film in the transverse direction, followed by heat treatment.

Preferably, the polyester multi-layer film may have a haze change of less than 0.5 when heat treated at 150° C. for 30 minutes.

### Advantageous Effects

A polyester multi-layer film according to an embodiment of the present invention has the effect of suppressing the generation of oligomers within the film and preventing their migration to the surface even during high-temperature processes.

In addition, a method for manufacturing a polyester multi-layer film according to an embodiment of the present invention has the effect of providing high economic efficiency by allowing the production of a polyester multi-layer films at a low manufacturing cost.

Moreover, the polyester multi-layer film according to an embodiment of the present invention may maintain excellent product quality in displays, semiconductors, and various industries through the aforementioned advantages, and significantly increase productivity by preventing contamination within the process due to oligomer scattering.

However, the effects of the present invention are not limited to the effects mentioned above, and other effects not mentioned will be clearly understood by those skilled in the art from the description below.

### BRIEF DESCRIPTION OF DRAWINGS

FIG. 1 is a cross-sectional view of a polyester multi-layer film according to an embodiment of the present invention.

FIG. 2 is a flowchart illustrating a method for manufacturing a polyester multi-layer film according to an embodiment of the present invention.

### MODE FOR INVENTION

The invention will be described more fully with reference to the accompanying drawings, in which example embodiments of the inventions are shown. This invention may, however, be embodied in many different forms and should not be construed as limited to only the embodiments set forth herein.

In the drawings, the thickness of layers and regions are exaggerated for clarity. Like reference numerals designate like elements throughout the specification. It will be understood that when an element such as a layer, film, region, or substrate is referred to as being “on” another element, it can be “directly on” the other element or intervening elements may also be present. In contrast, when an element is referred to as being “directly on” another element, there are no intervening elements present.

Unless otherwise defined, all technical and scientific terms used herein have the same meaning as commonly understood by one of ordinary skill in the art to which this invention belongs. In case of conflict, the present specification, including definitions, will control. Although methods and materials similar or equivalent to those described herein can be used in the practice or testing of the invention, suitable methods and materials are described herein.

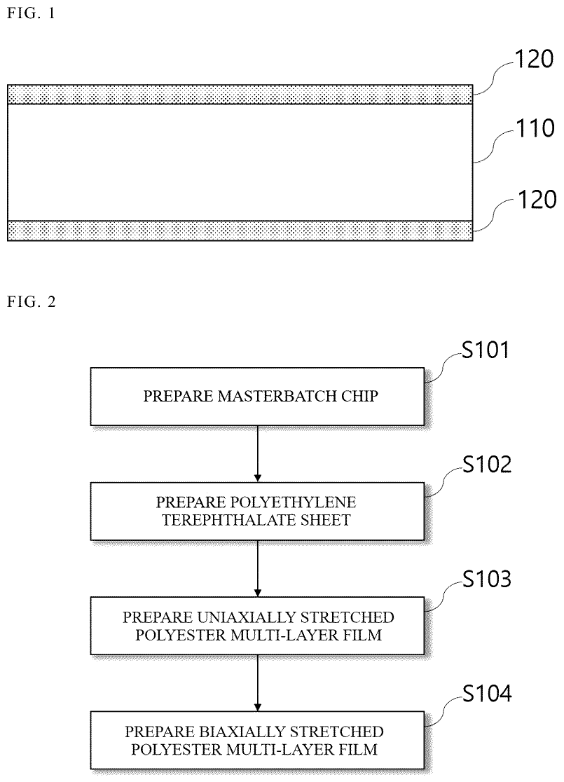

FIG. 1 is a cross-sectional view of a polyester multi-layer film according to an embodiment of the present invention.

Referring to FIG. 1, a polyester multi-layer according to an embodiment of the present invention includes a substrate layer 110 including polyester and a skin layer 120 located on at least one surface of the substrate layer 110. The example of FIG. 1 shows that the skin layers 120 are formed on both surfaces of the substrate layer 110, but the present invention is not limited thereto such that the skin layer 120 may be formed on only one surface of the substrate layer 110.

In the present invention, the skin layer 120 is located on at least one surface of the substrate layer 110 and includes polyester and an organic phosphorus compound. The inventors of the present invention have found that, in an effort to suppress the generation of oligomers within the film and their migration to the surface even at high temperatures, it is possible to solve this issue by adding a compound with a structure and size similar to that of cyclic C3, a representative oligomer, only to the skin layer during the film formation process of the polyester film. In particular, it was confirmed that organic phosphorus compounds among the substances with structures similar to the cyclic C3 substance exhibit excellent performance, leading to the completion of the present invention.

The polyester multi-layer film according to an embodiment of the present invention preferably satisfies the following Equations 1 (correlation coefficient) and Equation 2 (haze difference before and after heat treatment).

$$0.5 < [ C 3 ] / 10 , 000 - Δ H < 1 \qquad ( Equation 1 )$$

$$Δ H = H f - Hi < 0.5 \% \qquad ( Equation 2 )$$

In Equation 1 and Equation 2, [C3] represents the ppm concentration of C3 cyclic oligomers contained in the multi-layer film, Hi is the haze of the multi-layer film, and Hf is the haze (unit: %) of the multi-layer film after heat treatment at 150° C. for 30 minutes.

The polyester multi-layer film according to an embodiment of the present invention is characterized by including an organic phosphorus compound in the skin layer 120. The technical effects of the present invention can be achieved if the relationship between the C3 cyclic oligomers contained in the multi-layer film and the haze change before and after heat treatment satisfies the aforementioned Equations 1 and 2.

The concentration of C3 cyclic oligomers in the film and the haze change before and after heat treatment, as shown in Equation 1, generally have a close relationship. To maintain excellent optical properties, such as transparency, after heat treatment, it is necessary for the haze change according to Equation 2 to be less than 0.5% (Equation 2). If the haze change exceeds 0.5%, the transparency decreases, degrading the optical properties of the film. To achieve this, a method of significantly reducing the oligomer concentration in the film may be used. However, this requires the use of solid-state polymerized resin throughout the entire film, as will be discussed below, which is less economical. Therefore, in the present invention, by using general liquid-phase chips for the substrate layer 110 and using low-oligomer resin and C3-like compounds only for the skin layer 120, the overall oligomer concentration in the film is not significantly different from that when using liquid-phase polymerized resin, while effectively suppressing the generation and migration of oligomers.

Additionally, if the correlation coefficient between the C3 cyclic oligomer and the haze change in Equation 1 is 0.5 or less, resin with a low oligomer content, as will be discussed below, must be prepared and used, leading to economic issues, or otherwise, the haze change is too large to ensure transparency. Moreover, if the value of Equation 1 is 1 or more, the oligomer content in the film exceeds 15,000 ppm, reaching a saturation point, which is not desirable.

Generally, polyester films contain a certain amount of oligomers from the time they are made by polymerizing the raw material resin. The amount of oligomers included in the polyester film varies depending on the polymerization method, but typically approximately 0.5 to 2% based on a representative C3 cyclic oligomer. These oligomers migrate to the surface when the polyester film is exposed to heat above the glass transition temperature. Because the oligomers that migrate to the surface are highly crystalline, they appear on the surface as crystalline foreign matter measuring several micrometers (μm). These crystalline oligomers degrade the optical properties of the film, such as transparency, and may scatter during the film processing process, contaminating other objects or products, thus reducing productivity.

In addition, various methods have been employed to suppress the migration of oligomers to the surface of a polyester film. The most common method is to minimize the initial oligomer content by preparing resin through solid-state polymerization, thereby minimizing surface migration when heat is applied. In particular, resins produced through solid-state polymerization are known to have high molecular weights and high intrinsic viscosities, which also have the effect of suppressing the migration of oligomers. Another method involves using copolymer resins that include a certain amount of monomers such as cyclohexanedimethanol or isosorbide in the polyester molecule, which increase the amorphous region of the polymer relatively, allowing more oligomers to be contained, thereby suppressing the migration to the surface. Other known methods include using expensive catalysts such as germanium (Ge) or titanium (Ti) to minimize the generation of oligomers under high-temperature conditions during melt extrusion, and using a laminated film with high intrinsic viscosity resins in a skin layer to suppress the migration of oligomers. However, although these methods are somewhat effective, oligomers are continuously generated under the high-temperature conditions of the film formation or processing processes, so they have limitations in ultimately suppressing the migration of generated oligomers.

In contrast, the polyester multi-layer film according to an embodiment of the present invention inhibits the generation of oligomers and suppresses the migration of generated oligomers to the surface. According to an embodiment of the present invention, the polyester multi-layer film reaches an equilibrium state between polyester molecules and oligomers at a certain temperature. Specifically, at a temperature of 300° C. where the polyester film is produced, the equilibrium constant value reaches approximately 0.019, maintaining a stable equilibrium state. Based on this, it was found that the production of additional oligomers was suppressed by adding an appropriate amount of a compound with a structure similar to that of the representative C3 cyclic oligomer, considering the concentration in the equilibrium state. In particular, by using an organic phosphorus compound in a predetermined amount among substances with similar structures, the equilibrium state can be maintained even in high-temperature processes ranging from 250 to 300° C. during film formation, significantly suppressing the generation of oligomers and preventing their migration to the surface even during prolonged use at high temperatures. These results mean that even by using low-oligomer resin and phosphorus-like compounds only in the skin layer 120, which accounts for approximately 10% of the film, the overall oligomer level in the film can be stably maintained by suppressing the additional generation of oligomers, thereby suppressing migration to the surface.

The polyester multi-layer film according to an embodiment of the present invention preferably satisfies Equation 3 below. Specifically, it is preferable to satisfy the following equation 3 due to the organic phosphorus compound included in the skin layer 120.

$$10 , 000 < [ C 3 ] + [ P ] * 20 < 15 , 000 \qquad ( Equation 3 )$$

Here, [C3] represents the ppm concentration of C3 cyclic oligomers contained within the multi-layer film and [P] represents the ppm concentration of phosphorus (P) contained in the skin layer.

When the relationship value of the concentrations of [C3] and [P] in Equation 3 is 10,000 or less, the generation of oligomers is not sufficiently suppressed to prevent a desirable increase in haze, and when it is 15,000 or more, oligomer migration occurs, or an excessive amount of phosphorus compound is used, leading to scattering issues, which is not preferable.

Additionally, in the present invention, the concentration of C3 cyclic oligomers in the skin layer 120 is preferably set to 7,000 ppm or less. In this case, if it exceeds 7,000 ppm, some oligomers may migrate to the surface, which is not preferable.

To this end, the phosphorus content derived from the organic phosphorus compound in the skin layer 120 is preferably in the range of 100 to 400 ppm. In this case, if the content of the organic phosphorus compound is less than 100 ppm, it may not sufficiently suppress the oligomers, and if it exceeds 400 ppm, the excess compound may cause contamination during film production and is not economically desirable.

In the present invention, the organic phosphorus compound is preferably a trialkyl phosphite or a triaryl phosphite. Specifically, it is preferable to include at least one selected from Tri (2,4-di-tert-butylphenyl) phosphite, Bis(2,4-di-tert-butylphenyl) pentaerythritol diphosphite, Bis(2,6-di-tert-butyl-4-methylphenyl) pentaerythritol diphosphite, and Bis(2,4-dicumylphenyl) pentaerythritol diphosphite. Although phosphate-based, phosphonate-based, or phosphinite-based compounds may also be used, they lack structural flexibility and are not sufficiently compatible with polyester, so they do not exhibit a sufficient oligomer suppression effect.

In the present invention, the organic phosphorus compound preferably has a molecular weight of 400 g/mol or more and 900 g/mol or less. In this case, if the molecular weight of the organic phosphorus compound falls outside this range, the similarity to the C3 cyclic oligomer molecules is insufficient, making it difficult to maintain an equilibrium state effectively. The organic phosphorus compound included in the skin layer 120 acts like the C3 cyclic oligomer to maintain an equilibrium state at high temperatures, thereby suppressing the generation of C3 cyclic oligomers within the film.

The thickness ratio of the substrate layer 110 to the skin layer 120 in the polyester multi-layer film according to an embodiment of the present invention is preferably in the range of 6:1 to 13:1. If the ratio is larger, the generation of oligomers is suppressed, but the suppression of migration may not be sufficient. If the ratio is smaller, the suppression of migration is effective, but it is not economically desirable.

FIG. 2 is a flowchart illustrating a method for manufacturing a polyester multi-layer film according to an embodiment of the present invention.

Referring to FIG. 2, a method for manufacturing a polyester multi-layer film according to an embodiment of the present invention includes the steps of: preparing a master-batch chip by compounding an organic phosphorus compound separately from polyester resin (S101), preparing a polyethylene terephthalate sheet by blending the prepared master-batch chip with polyester resin and then co-extruding it onto a polyester film (S102), preparing a uniaxially stretched polyester multi-layer film by uniaxially stretching the polyethylene terephthalate sheet in the machine direction and then cooling it to room temperature (S103), and preparing a biaxially stretched polyester multi-layer film by biaxially stretching the uniaxially stretched polyester multi-layer film in the transverse direction, followed by heat treatment (S104).

First, the step S101 of preparing a master-batch chip involves melt-extruding the polyester resin while adding the organic phosphorus compound through a side feeder, cooling and drying the extruded resin, and then cutting it to a predetermined size to prepare the chip. The organic phosphorus compound included in the skin layer of the present invention is characterized by being compounded separately from the polyester resin to prepare master-batch chips, which are then blended with the polyester resin and added during the film formation process. In this case, although there is a method of adding the organic phosphorus compound during the polymerization step of preparing the resin, adding the necessary amount may inhibit the activity of the catalysts essential for polymerization, leading to prolonged reaction times, and there is a potential issue of the organic phosphorus compound changing during long reaction, making this method undesirable.

Next, in the step S102 of preparing the polyethylene terephthalate sheet, polyester resin is used as the substrate layer raw material, a blend of the polyester resin and the polyester master-batch chip prepared in step S101 is used as the skin layer raw material, and these materials are co-extruded to prepare the polyethylene terephthalate sheet. At this point, the skin layer raw material is a blend of the prepared master-batch and the polyester resin to achieve a predetermined phosphorus compound content.

Next, the step S103 of preparing the uniaxially stretched polyester multi-layer film by stretching the polyethylene terephthalate sheet in the machine direction and then cooling it to room temperature involves stretching the prepared polyethylene terephthalate sheet 3 to 5 times in the machine direction (MD) and then cooling it to room temperature to prepare the uniaxially stretched polyester multi-layer film.

Next, the step S104 of preparing the biaxially stretched polyester multi-layer film by biaxially stretching the uniaxially stretched polyester multi-layer film in the transverse direction, followed by heat treatment involves stretching the uniaxially stretched polyester multi-layer film 3 to 5 times in the transverse direction (TD), heat-treating the biaxially stretched polyester multi-layer film at a temperature of 230 to 250° C., and then heat-setting it at a temperature of 200 to 220° C. to prepare the biaxially stretched polyester multi-layer film.

However, in the description of the present invention, stretching is not limited to biaxial stretching, and the film may also be prepared by non-stretching or uniaxial stretching as needed.

The polyester multi-layer film prepared as described above preferably maintains a haze change of less than 0.5% when heat-treated at a temperature of 150° C. for 30 minutes.

The polyester multi-layer film with excellent transparency prepared by the above-mentioned manufacturing method does not experience oligomer migration at high temperatures, thereby maintaining its transparency, and also suppresses the scattering of oligomers during the manufacturing process, ensuring a clean production environment.

Hereinafter, the present disclosure will be described in further detail with reference to Examples. The following Examples are provided to illustrate further the present disclosure and are not intended to limit the scope of the present invention.

### Preparation Example

### (1) Preparation of Polyester Resin A and B

100 parts by weight of terephthalic acid and 60 parts by weight of ethylene glycol were used as starting raw materials, magnesium acetate tetrahydrate was added as a catalyst, and a mixture was put into a reactor. The reaction initiation temperature was set to 150° C., and the reaction temperature was gradually raised, reaching 230° C. after 3 hours. After an additional 4 hours, the ester exchange reaction was substantially completed. This reaction mixture was transferred to a polycondensation reactor, where antimony trioxide was added, and a polycondensation reaction was carried out for 4 hours to obtain polyester resin A with an intrinsic viscosity of 0.61 and a C3 cyclic oligomer content of 9,990 ppm.

Next, solid-state polymerization was performed using the polyester resin A obtained above under nitrogen conditions at a temperature of 215° C. to obtain polyester resin B with an intrinsic viscosity of 0.81 and a C3 cyclic oligomer content of 4,000 ppm.

### (2) Preparation of Master-Batch Chips of Organic Phosphorus Compound

After removing moisture from the polyester resin B obtained in the above polyester resin preparation, it was put into a twin-screw extruder and melt-extruded at 280° C. while adding Tri (2,4-di-tert-butylphenyl)phosphite (produced by BASF) as a phosphorus compound, through a side feeder. At this time, the master-batch contained 5 parts by weight of the phosphorus compound based on 100 parts by weight of polyester. Next, the polymer strand coming out of the extruder was cooled in water and air-dried, then cut into a predetermined size to produce master-batch C.

### (3) Preparation of Polyester Multi-Layer Film

The polyester resin A, from which moisture had been removed, was used as a substrate layer (main layer) material, and the polyester resin B and the master-batch C were blended to achieve a predetermined phosphorus compound content, then fed into a co-extruder. By calibrating a feeder block, the ratio of the main layer to the skin layer was adjusted to between 6:1 and 15:1, and extrusion was carried out. The extruded material was rapidly cooled and solidified on a casting drum with a surface temperature of 20° C. to prepare polyethylene terephthalate sheet with a thickness of 8,000 μm. Next, the prepared polyethylene terephthalate sheet was stretched 3 to 5 times in the machine direction (MD) at 80° C. and then cooled to room temperature. Afterwards, the temperature was raised sequentially in a tenter for preheating and drying, and then it was stretched 3 to 5 times in the transverse direction (TD). After that, heat treatment was performed at 230 to 250° C. in the tenter and heat setting at 200 to 220° C. was performed to prepare a biaxially stretched multi-layer film.

### EXAMPLES

### Example 1

A polyester multi-layer film with a thickness of 50 μm, with skin layers formed on both sides of a substrate layer, was prepared by co-extrusion at 280° C., where polyester resin A, polyester resin B, and master-batch C were blended to achieve a phosphorus content of 250 ppm and used as the raw material for the skin layer while polyester resin A was used for the substrate layer. At this time, the thickness ratio of the skin layer, the substrate layer, and the skin layer was 1:13:1. The C3 cyclic oligomer content, the haze change before and after 30 minutes of heat treatment at 150° C. according to Equation 2, and the correlation coefficient according to Equation 1 for the prepared polyester multi-layer film are shown in Table 1 below (the same applies hereinafter).

### Example 2

A polyester multi-layer film was prepared in the same manner as in Example 1, except that the phosphorus content in the skin layer was set to 150 ppm.

### Example 3

A polyester multi-layer film was prepared in the same manner as in Example 1, except that the thickness ratio of the skin layer, the substrate layer, and the skin layer was set to 1:6:1.

### Example 4

A polyester multi-layer film was prepared in the same manner as in Example 1, except that the thickness of the polyester multi-layer film was set to 188 μm.

### COMPARATIVE EXAMPLES

### Comparative Example 1

A polyester multi-layer film was prepared in the same manner as in Example 1, except that polyester resin A and master-batch C were blended to achieve a phosphorus content of 250 ppm and used as the raw material for the skin layer, while polyester resin A was used as the raw material for the substrate layer.

### Comparative Example 2

A polyester multi-layer film was prepared in the same manner as in Example 1, except that polyester resin A and master-batch C were blended to achieve a phosphorus content of 250 ppm and used as the raw material for the skin layer, while polyester resin B was used as the raw material for the substrate layer.

### Comparative Example 3

A polyester multi-layer film was prepared in the same manner as in Example 1, except that polyester resin A and polyester resin B were blended (excluding master-batch C) and used as the raw materials for the skin layer and the main layer, respectively.

### Comparative Example 4

A polyester multi-layer film was prepared in the same manner as in Example 1, except that triphenyl phosphate (from Green Chemical Co., Ltd.) was used as a phosphorus compound.

### Comparative Example 5

A polyester multi-layer film was prepared in the same manner as in Example 1, except that the ratio of the skin layer, the substrate layer, and the skin layer was set to 1:15:1.

### Comparative Example 6

A polyester multi-layer film was prepared in the same manner as in Example 1, except that the phosphorus content in the skin layer was set to 80 ppm.

### Comparative Example 7

A polyester multi-layer film was prepared in the same manner as in Example 1, except that the phosphorus content in the skin layer was set to 450 ppm.

The physical properties of the polyester multi-layer films prepared in Examples 1 to 4 and Comparative Examples 1 to 7 were evaluated through the following experimental examples, and the results are shown in Table 1.

### Experimental Examples

### (1) Measurement of C3 Cyclic Oligomer Content

After dissolving 50 mg of the prepared multi-layer film in a mixed solution of chloroform/1,1,1,3,3,3-hexafluoro-2-propanol (mixing ratio: 3/2), it was reprecipitated with chloroform/methanol (mixing ratio: 2/1), and filtered through a 5 μm filter, and the solvent was removed. Then, the obtained precipitate was dissolved in a predetermined amount of DMF, and the amount of C3 cyclic oligomers was measured using HPLC (Agilent 1200 series).

Here, the amount of oligomers measured using HPLC was obtained from the commonly used peak area ratio of the standard sample peak area to the measurement sample peak area (absolute calibration method). The column used was Polaris 5 Si 100*4.6 mm, the temperature was 40° C., the mobile phase was hexane/1,4-dioxane (6:4), the flow rate was 1.0 ml/min, and the detector used was 240 nm UV.

### (2) Measurement of Phosphorus (P) Content

After freeze-milling 1 g of the sample, a thin film sample with a thickness of 1 mm was made by hand pressing, and the phosphorus content was measured using an XRF-Minipal 4 device (from PANalytical). The calibration curve was obtained using a polyester fiber containing a quantified amount of phosphorus pentoxide.

### (3) Measurement of Haze (H)

The haze Hi of the film prepared as a sample was measured using a haze meter NDH-5000 (from Nippon Denshoku Industries Co., Ltd.) according to ASTM-D1003.

Next, the prepared film sample was fixed to a rectangular metal support and left in an oven at 150° C. for 30 minutes for high-temperature heat treatment, and then the haze Hf after heat treatment was measured.

The difference ΔH in film haze before and after heat treatment was calculated by subtracting the haze Hi before heat treatment from the haze Hf after heat treatment.

### (4) Surface State Analysis by Optical Microscope

After the prepared film sample was fixed to a rectangular metal support, the surface of the prepared film sample, both before and after high-temperature heat treatment in a 150° C. oven for 30 minutes, was analyzed using an optical microscope (from Olympus corporation, MXSOLT-1273MH) over an area of 2*2 mm. The blooming phenomenon caused by oligomer crystals larger than microns was observed and classified as follows:
O: Not observed at all
Δ: Vaguely observed
X: Observed extensively across the surface

The physical properties of the multi-layer films prepared in the above examples and comparative examples are summarized in Table 1. In Table 1, [C3] represents the concentration of C3 cyclic oligomers in the entire multi-layer film.

TABLE 1

| | | | Correlation | | | |
|---|---|---|---|---|---|---|
| | | ΔH (%) | coefficient | P | | Sur- |
| | [C3] | (Equation | (Equation | content | Equation | face |
| Sample | (ppm) | 2) | 1) | (ppm) | 3 | state |
| Example 1 | 9,200 | 0.20 | 0.72 | 250 | 14,200 | O |
| Example 2 | 9,189 | 0.31 | 0.61 | 150 | 12,189 | O |
| Example 3 | 8,600 | 0.11 | 0.75 | 250 | 13,600 | O |
| Example 4 | 9,199 | 0.41 | 0.51 | 250 | 14,199 | O |
| Comparative | 9,990 | 5.20 | −4.20 | 250 | 14,990 | X |
| Example 1 | | | | | | |
| Comparative | 5,500 | 4.62 | −4.07 | 250 | 10,500 | X |
| Example 2 | | | | | | |
| Comparative | 7,550 | 5.31 | −4.56 | — | 7,550 | X |
| Example 3 | | | | | | |
| Comparative | 9,220 | 2.31 | −1.39 | 250 | 14,220 | X |
| Example 4 | | | | | | |
| Comparative | 9,900 | 0.52 | 0.47 | 250 | 14,900 | Δ |
| Example 5 | | | | | | |
| Comparative | 9,222 | 0.81 | 0.11 | 80 | 10,822 | Δ |
| Example 6 | | | | | | |
| Comparative | 9,205 | 0.23 | 0.69 | 450 | 18,205 | Δ |
| Example 7 | | | | | | |

As shown in Table 1 above, the polyester multi-layer film according to the present invention exhibits excellent transparency and prevents oligomer migration to the surface because it satisfies the correlation coefficient (Equation 1) regarding the concentration of C3 cyclic oligomers and the change in haze before and after heat treatment. Through this, it is possible to provide a polyester multi-layer film that can fundamentally prevent any reduction in productivity due to external scattering.

On the other hand, Comparative Examples 1 to 6, where the value of the correlation coefficient (Equation 1) is 0.5 or less, especially Comparative Examples 1 to 4 with very low values of Equation 1, show a significant change in haze before and after heat treatment and an extensive blooming phenomenon on the surface. Although Comparative Examples 5 and 6 have greater values of Equation 1 than Comparative Examples 1 to 4, they still show some blooming phenomenon on the surface as their values are 0.5 or less.

Additionally, Comparative Example 7, where the value of Equation 3 exceeds 15,000, shows some blooming phenomenon on the surface due to the excess phosphorus compound.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A polyester multi-layer film comprising:
a substrate layer comprising polyester; and
a skin layer located on at least one surface of the substrate layer and comprising polyester and an organic phosphorus compound,
wherein the polyester multi-layer film satisfies Equation 1 and Equation 2 below,
$$0.5 < [ C 3 ] / 10 , 000 - Δ H < 1 \qquad ( Equation 1 )$$
$$Δ H = H f - Hi < 0.5 \% , \qquad ( Equation 2 )$$
where [C3] represents a ppm concentration of C3 cyclic oligomers contained in the multi-layer film, Hi is a haze of the multi-layer film, and Hf is a haze (unit: %) of the multi-layer film after heat treatment at 150° C. for 30 minutes.

2. The polyester multi-layer film of claim 1, wherein the polyester multi-layer film satisfies Equation 3 below,
$$10 , 000 < [ C 3 ] + [ P ] * 20 < 15 , 000 , \qquad ( Equation 3 )$$
where [C3] represents a ppm concentration of C3 cyclic oligomers contained within the multi-layer film and [P] represents a ppm concentration of phosphorus (P) contained in the skin layer.

3. The polyester multi-layer film of claim 1, wherein the skin layer has a C3 cyclic oligomer concentration of 7,000 ppm or less.

4. The polyester multi-layer film of claim 1, wherein the organic phosphorus compound has a molecular weight of from 400 to 900 g/mol.

5. The polyester multi-layer film of claim 1, wherein the organic phosphorus compound acts like a C3 cyclic oligomer, allowing for an equilibrium state to be maintained at high temperatures, thereby suppressing generation of C3 cyclic oligomers within a film.

6. The polyester multi-layer film of claim 1, wherein the organic phosphorus compound is at least one selected from triaryl phosphite and trialkyl phosphite.

7. The polyester multi-layer film of claim 1, wherein the organic phosphorus compound in the skin layer is added as a master-batch chip that is produced by compounding an organic phosphorus compound separately from polyester resin.

8. The polyester multi-layer film of claim 1, wherein a thickness ratio of the substrate layer to the skin layer is in the range of 6:1 to 13:1.

9. A method for manufacturing a polyester multi-layer film, comprising the steps of:
preparing a master-batch chip by compounding an organic phosphorus compound separately from polyester resin;
preparing a polyethylene terephthalate sheet by blending the prepared master-batch chip with polyester resin and then co-extruding it onto a polyester film;
preparing a uniaxially stretched polyester multi-layer film by uniaxially stretching the polyethylene terephthalate sheet in a machine direction and then cooling it to room temperature; and
preparing a biaxially stretched polyester multi-layer film by biaxially stretching the uniaxially stretched polyester multi-layer film in a transverse direction, followed by heat treatment.

10. The method of claim 9, wherein the polyester multi-layer film has a haze change of less than 0.5 when heat treated at 150° C. for 30 minutes.
